(19) United States
(12) Patent Application Publication
(10) Pub. No.: US 2006/0285753 A1
(43) Pub. Date: Dec. 21, 2006

(54) Medical image conversion apparatus, medical image output system and medical image output program

(75) Inventor: Toshio Yamasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/453,906

(22) Filed: Jun. 16, 2006

(30) Foreign Application Priority Data
Jun. 16, 2005 (JP) 2005-176262

(51) Int. Cl. G06K 9/62

(52) U.S. Cl. 382/209

(57) ABSTRACT

Disclosed is a medical image output system including: a medical image conversion apparatus to convert a file format of medical image data including received medical image information and patient character information and to transfer it; and a medical image formation apparatus to form an image of the transferred medical image data, wherein the medical image conversion apparatus includes: a reception section; a storage section to store a template; a conversion section to convert the template in accordance with an aspect ratio of the medical image information; a template data generation section; and a transfer section to transfer the template data to the medical image formation apparatus, and wherein the medical image formation apparatus includes: a template data conversion section to convert the template data to have an aspect ratio of the original template; and an image formation member to form an image onto the recording medium.

### BACKGROUND OF THE INVENTION

1. Field of the Invention

The present invention generally relates to a medical image output system equipped with a medical image conversion apparatus converting medical image data and an image formation apparatus performing the image formation of medical image data transferred from the medical image conversion apparatus on a recording medium, and a medical image output program.

2. Description of Related Art

There has been conventionally known a medical image transfer apparatus transferring a medical image radiographed to be generated by a medical image generation apparatus (hereinafter referred to as a modality) such as a computed tomography (CT), a computed radiography (CR), a magnetic resonance imaging (MRI), a mammography apparatus, an ultrasonic diagnostic apparatus and the like to a film output apparatus (medical image formation apparatus) and the like.

After the medical image transfer apparatus has converted medical image data generated by the modality into the data in conformity with, for example, the Digital Imaging and Communications in Medicine (DICOM) standard, the medical image transfer apparatus transfers the converted data to the medical image formation apparatus. The medical image formation apparatus performs the image formation of a medical image based on the transferred medical image data on a film to create a hard copy of the medical image.

FIG. 16A is an example of the medical image generated by a diagnostic apparatus. As shown in the view, the medical image 80 is composed of, for example, a diagnostic image 82, which is a tomographic image of a subject, and patient information 81 such as the ID number, the name, the distinction of sex, the age and the like of a patient.

A conversion apparatus performs the data conversion of each of the medical image data generated by the diagnostic apparatus and the patient information extracted from the medical image data, and transmits the converted data to an output apparatus. At this time, the conversion apparatus outputs format information indicating the arrangement method of a medical image into two horizontal frames and two vertical frames (2×2), three horizontal frames and four vertical frames (3×4), or the like to an output apparatus in the form in conformity with the DICOM standard.

Moreover, there has been recently disclosed a technique of calculating an enlargement or reduction ratio of a diagnostic image in accordance with set information of an output apparatus to transfer patient information to the output apparatus using a character type and a character size selected according to the calculated enlargement or reduction ratio at the time of transferring the diagnostic image and the patient information in medical image data generated by a diagnostic apparatus (see JPA 2002-190937, hereinafter referred to as “Patent Document 1”).

An example of the medical image generated by the invention described in Patent Document 1 is shown in FIG. 16B. The output apparatus arranges the medical image in the format of “2×2” in an image rendering region 84 on a recording medium 83 according to format information, and performs the image formation of the patient information in a character rendering region 85.

On the other hand, because the diagnostic image transmitted from a diagnostic apparatus has not always the aspect ratio of 1:1 but the aspect ratio changes according to a diagnostic apparatus, the enlargement and reduction image processing is needed for each diagnostic image. Moreover, there is a problem of deterioration of the image caused by the performance of the image processing based on the aspect ratio to cause an erroneous diagnosis.

### SUMMARY OF THE INVENTION

The present invention was made in view of the problem mentioned above. It is one of objects of the present invention to realize the output of image data which has been transmitted from a diagnostic apparatus and has different aspect ratios in a unified aspect ratio of 1:1. Moreover, it is another object of the invention to make it possible to decrease the number of times of image processing to suppress the deterioration of the image caused by the image processing by enlarging or reducing template data in accordance with the aspect ratio of image data instead of enlarging or reducing the image data.

In order to solve the above problem, according to a first aspect of the invention, a medical image output system comprises: a medical image conversion apparatus to convert a file format of medical image data including received medical image information and patient character information into a predetermined data format, and to transfer the converted medical image data; and a medical image formation apparatus to form an image of the transferred medical image data in the predetermined data format on a recording medium, wherein the medical image conversion apparatus comprises: a reception section to receive the medical image data; a storage section to store a template in which the medical image information is embedded, among the medical image data received by the reception section; a conversion section to convert the template stored in the storage section in accordance with an aspect ratio of the medical image information; a template data generation section to embed the medical image information into the template converted by the conversion section so as to generate template data; and a transfer section to transfer the template data generated by the template data generation section to the medical image formation apparatus, and wherein the medical image formation apparatus comprises: a template data conversion section to convert the template data transferred from the transfer section to have an aspect ratio of the original template stored in the storage section; and an image formation member to form an image of the template data converted by the template data conversion section onto the recording medium.

According to the first aspect, even when a medical image transmitted from a diagnosis apparatus dose not have an aspect ratio of 1:1, the image is converted to be an aspect ratio of 1:1 by image processing and the image is embedded to a previously formed template together with patient information. Thus, it becomes possible to output appropriate medical image having an aspect ratio of 1:1 regardless of an aspect ratio of the transmitted medical image.

Further, the template is formed in accordance with an aspect ratio of the medical image, and the template is enlarged or reduced after the image is embedded to the template, rather than image processing is given to the medical image. Thus, the number of image processing can be reduced and deterioration of the image can be reduced to minimum. As a result, it becomes possible to avoid misdiagnosis which can be caused by deterioration of the image.

Preferably, the medical image conversion apparatus further comprises: a specification section to specify format information which indicates an arrangement method of the medial image data including the medical image information and the patient character information on the recording medium, and wherein the storage section stores the template formed in conformity with the format information specified by the specification section.

Preferably, when the reception section receives the medical image data having an aspect ratio of not 1:1, the conversion section converts the template so as to have the same aspect ratio as the aspect ratio of the received medical image information.

Preferably, the template data conversion section converts the aspect ratio of the template data generated by the template data generation section into the same aspect ratio as the aspect ratio of the template.

Preferably, the template stored in the storage section has the aspect ratio of 1:1.

Preferably, the conversion section converts the template data so as to have the same aspect ratio as the aspect ratio of the medical image information after the patient character information is written into the template.

According to a second aspect of the invention, a medical image conversion apparatus, comprises: a reception section to receive medical image data including medical image information and patient character information; a storage section to store a template in which the medical image information is embedded among the medical image data received by the reception section; a medical image information conversion section to convert an aspect ratio of the medical image information into a same aspect ratio as the aspect ratio of the template stored in the storage section; a template data generation section to embed the medical image information converted by the medical image information conversion section into the template so as to generate template data; and a transfer section to transfer the template data generated by the template data generation section.

According to the second aspect, even when a medical image transmitted from a diagnosis apparatus dose not have an aspect ratio of 1:1, the image is converted to be an aspect ratio of 1:1 by image processing and the image is embedded to a previously formed template together with patient information. Thus, it becomes possible to output appropriate medical image having an aspect ratio of 1:1 regardless of an aspect ratio of the transmitted medical image.

Further, the template is formed in accordance with an aspect ratio of the medical image, and the template is enlarged or reduced after the image is embedded to the template, rather than image processing is given to the medical image. Thus, the number of image processing can be reduced and deterioration of the image can be reduced to minimum. As a result, it becomes possible to avoid misdiagnosis which can be caused by deterioration of the image.

Preferably, the medical image information conversion section converts the aspect ratio of the medical image information into 1:1.

According to a third aspect of the invention, a medical image output program comprises: a medical image conversion program to convert a file format of medical image data including received medical image information and patient character information into a predetermined data format, and to transfer the converted medical image data; and a medical image formation program to form an image of the transferred medical image data in the predetermined data format on a recording medium, wherein the medical image conversion program makes a computer function as: a reception section to receive the medical image data; a storage section to store a template in which the medical image information is embedded, among the medical image data received by the reception section; a conversion section to convert the template stored in the storage section in accordance with an aspect ratio of the medical image information; a template data generation section to embed the medical image information into the template converted by the conversion section so as to generate template data; and a transfer section to transfer the template data generated by the template data generation section to the medical image formation apparatus, and wherein the medical image formation program makes a computer function as: a template data conversion section to convert the template data transferred from the transfer section to have an aspect ratio of the original template stored in the storage section; and an image formation member to form an image of the template data converted by the template data conversion section onto the recording medium.

According to the third aspect, even when a medical image transmitted from a diagnosis apparatus dose not have an aspect ratio of 1:1, the image is converted to be an aspect ratio of 1:1 by image processing and the image is embedded to a previously formed template together with patient information. Thus, it becomes possible to output appropriate medical image having an aspect ratio of 1:1 regardless of an aspect ratio of the transmitted medical image.

Further, the template is formed in accordance with an aspect ratio of the medical image, and the template is enlarged or reduced after the image is embedded to the template, rather than image processing is given to the medical image. Thus, the number of image processing can be reduced and deterioration of the image can be reduced to minimum. As a result, it becomes possible to avoid misdiagnosis which can be caused by deterioration of the image.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a diagram showing an example of the system configuration of a medical image output system according to a first embodiment;

FIG. 2 is a diagram showing the configuration of the principal part of a controller constituting the medical image output system;

FIGS. 3A, 3B and 3C are views showing the examples of formats at the time of arranging a medical image according to format information;

FIG. 4 is a diagram showing the configuration of the principal part of a conversion apparatus constituting the medical image output system;

FIGS. 5A and 5B are views showing examples of medical images having different aspect ratios;

FIGS. 6A and 6B are views showing examples of medical images when an medical image having an aspect ratio of 1:2 is enlarged or reduces;

FIGS. 7A and 7B are diagrams showing examples of the data configurations of a storage unit and a memory, each constituting the conversion apparatus;

FIG. 8 is a view for illustrating template data;

FIG. 9 is a flowchart showing the processing executed by the conversion apparatus;

FIG. 10 is a diagram showing an example of the data configuration of a storage unit constituting a conversion apparatus according to a second embodiment;

FIG. 11 is a diagram showing an example of the data configuration of a memory constituting the conversion apparatus according to the second embodiment;

FIGS. 12A, 12B and 12C are diagrams for illustrating the calculation method of enlargement and reduction ratios;

FIGS. 13-1, 13-2A, 13-2B, 13-3 and 13-4 are views showing examples of template creation;

FIG. 14 is a view for illustrating the outline of the operation of the conversion apparatus and a film output apparatus, each being in accordance with the second embodiment;

FIG. 15 is a flowchart showing the processing executed by the conversion apparatus according to the second embodiment; and

FIG. 16A is an example of a medical image, and FIG. 16B is a view showing an example of the film in which the medical image is formatted.

### DETAILED DESCRIPTION OF THE PREFERRED EMBODIMENTS

In the following, embodiments of the present invention are described in detail with reference to the drawings.

### First Embodiment

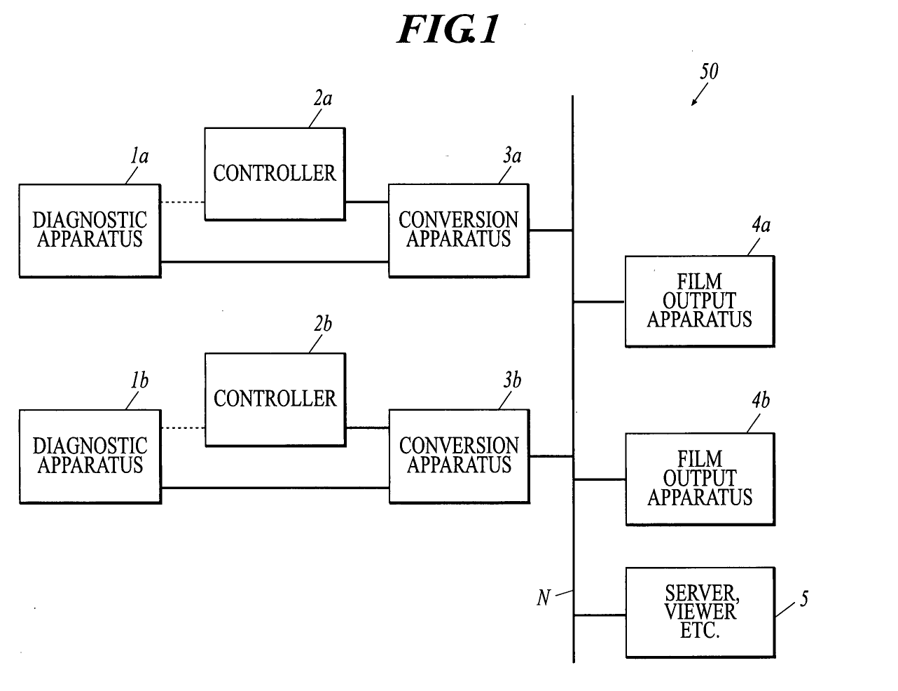

FIG. 1 shows an example of the system configuration of a medical image output system 50 according to a first embodiment. As shown in the diagram, the medical image output system 50 is composed of a conversion apparatus 3a transferring an medical image output from a diagnostic apparatus 1a according to an instruction of a controller 2a, a conversion apparatus 3b transferring medical image data output from a diagnostic apparatus 1b according to an instruction of a controller 2b, film output apparatus 4a and 4b, and a server 5, each connected with each other through a communication network N.

Hereupon, the communication network N is a network such as a public network, a telephone line, an ISDN circuit, a wireless circuit, a leased line and the like. What is requested to the communication network N is just to be capable of connection at an arbitrary time, and it is not necessary to be always connected. Moreover, it is desirable that the communication network N secures the security by which only a specific user can access from a viewpoint of the reliability of information management.

The diagnosis apparatus 1a and 1b are medical image generation apparatus generating the data of a radiographed medical image (it is an analog or digital video signal, and this data is hereinafter referred to as medical image data). As the diagnosis apparatus 1a and 1b, a CR and a CT, each performing radiography by radiating an X-ray and reading an X-ray image stored in a photostimulable phosphor plate by the radiography to generate digital data, an MRI and an ultrasonic diagnostic apparatus, each radiating a wave other than the X-ray, and the like can be applied.

Each of the diagnosis apparatus 1a and 1b is composed of a control unit, a radiographing unit, a display unit, an input unit, a communication interface unit and the like. The control unit synthesizes patient information such as the patient ID, the name, the distinction of sex, the age and the like, which have been input from the input unit, with a subject image which the radiographing unit has radiographed to generate medical image data, and transmits the generated medical image data to the controllers 2a and 2b and the conversion apparatus 3a and 3b through the communication interface unit.

The controllers 2a and 2b perform, for example, the setting of the arrangement method of a medical image, the output of an image indicating the frame positions of the medical image when the medical image is arranged based on the setting to display the output medical image, and the like. For example, the controllers 2a and 2b perform the enlargement or the reduction of the images having different aspect ratios transmitted from the diagnostic apparatus 1a and 1b, respectively, by the manipulation of the input unit. The aspect ratio means a ratio of the length and the breadth of a medical image.

The conversion apparatus 3a and 3b reads medical image data output from the diagnosis apparatus 1a and 1b, respectively, one piece by one piece, and perform the data conversion of the read medical image data in conformity with the DICOM standard to store the converted data. Then, the conversion apparatus 3a and 3b transfer the converted data to the film output apparatus 4a and 4b, which has been set in advance.

The film output apparatus 4a and 4b are medical image formation apparatus performing the image formation of patient information format data and position data, both corresponding to the patient information, and image data based on image format data among the data which has been transferred from the conversion apparatus 3a and 3b and has been converted to the DICOM standard to output the data onto a film (recording medium). The film output apparatus 4a and 4b are severally composed of a control unit, a storage unit, an image memory, an exposure unit, a development unit, a communication unit, an ejection unit and the like. A film is made by coating an emulsion containing a photosensitive and thermosensitive material on a support member made of polyethylene terephthalate (PET) or the like to form a photosensitive layer.

The film is conveyed to each configuration unit by the control of a conveyance unit by the control unit. The exposure unit radiates a laser light onto the film to perform exposure, and forms a latent image of an image based on the data transferred from the conversion apparatus 3a and 3b. The development unit develops the latent image formed by the exposure by heating the film after the exposure. Then, the developed film is ejected from the ejection unit. In addition, although the medical image formation apparatus is configured in order to be applied to the film output apparatus, the medical image formation apparatus is not limited to such a configuration. For example, the medical image formation apparatus may be configured in order to be applied to an image formation apparatus such as a laser printer, an inkjet printer and the like.

A user determines whether to output the medical image data generated by the diagnosis apparatus 1a and 1b to the film output apparatus 4a and 4b or not by operating the controllers 2a and 2b, respectively. The controllers 2a and 2b severally makes the display units display an image every one page of the film.

The user operates the controller 2a and 2b to set the arrangement method of a medical image. After fixing the arrangement method, the medical image generated by the diagnostic apparatus 1a or 1b is subjected to the data conversion by the conversion apparatus 3a or 3b, respectively, and are transferred to either of the film output apparatus 4a and 4b which has been set in advance through the communication network N. The film output apparatus 4a or 4b enlarges or reduces the image based on the template data transmitted from the conversion apparatus 3a or 3b to form the enlarged or reduced image on a film.

The template data is a piece of image data in which medical images and patient information are embedded therein beforehand and are formatted according to the arrangement method and the medical image size which have been set by the user, i.e. a template image, and the template data is generated in the data format in conformity with a DICOM standard.

The server 5 is made of a database or the like which stores and manages the medical image data converted by the conversion apparatus 3a and 3b and the template data. Moreover, the server 5 may be equipped with a viewer capable of performing the display and the output of the images based on medical image data and template data which are stored in the database.

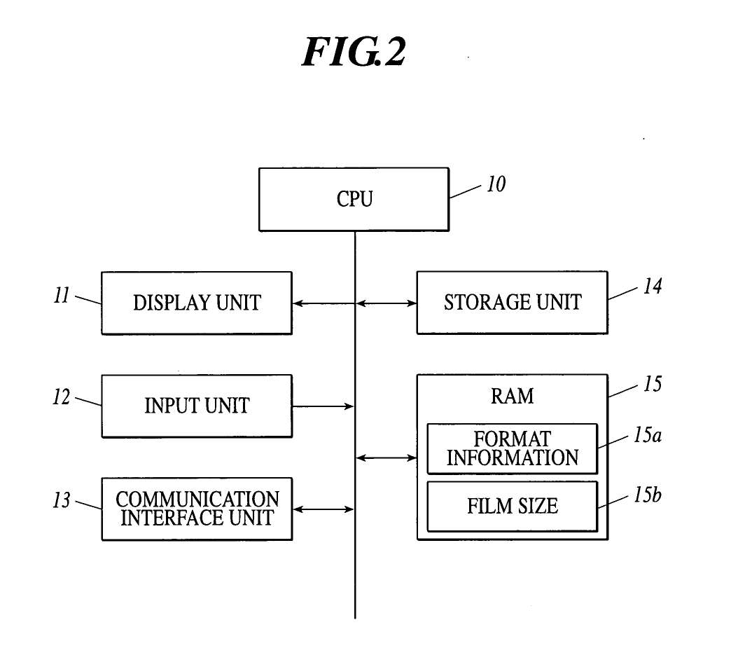

Next, FIG. 2 shows the configuration of the principal part of the controller 2a. As shown in the diagram, the controller 2a is composed of a central processing unit (CPU) 10, a display unit 11, an input unit 12, a communication interface unit 13, a storage unit 14 and a random access memory (RAM) 15. In addition, because the controller 2b also has the configuration similar to that of the controller 2a, the description and the illustration of the controller 2b are omitted.

The CPU 10 is a central processing unit executing the processing based on a predetermined program in accordance with an input instruction to transfer instruction and data to each function unit. To put it more concretely, the CPU 10 reads a program stored in the storage unit 14 according to the operation signal input from the input unit 12, and executers the processing according to the program. Then, the CPU 10 makes the display unit 11 display the processing result.

The display unit 11 is made of a cathode-ray tube (CRT), a liquid crystal display (LCD) or the like, and performs the display and the output of various screens based on the display data input from the CPU 10.

The input unit 12 is equipped with a keyboard including cursor keys, numeric keys, various function keys and the like, and pointing devices such as a mouse and the like. The input unit 12 outputs a depression signal of a depressed key, the position signal of a mouse, and the like to the CPU 10.

The communication interface unit 13 is a function unit performing the reception and the demodulation of a medical image data output from the diagnostic apparatus 1a and the transmission of format information 15a and a film size 15b, both stored in the RAM 15, to the conversion apparatus 3a. The communication interface unit 13 is made of, for example, a serial interface such as RS232C, a parallel interface such as Centronics, a USB or the like.

The storage unit 14 is a function unit equipped with a storage medium made of a hard disk device (HDD) which data can be read from and written into, and stores various programs and data.

The RAM 15 expands various programs to be executed by the CPU 10 into a program storage area. The RAM 15 temporarily stores data such as a processing result generated at the time of execution of various programs into a work area. As shown in the diagram, the RAM 15 stores the format information 15a and the film size 15b.

The format information 15a is the information indicating an arrangement method of a medical image, namely by what kind of a frame arrangement the medical image is arranged on a film, and is set by the user. The CPU 10 makes the display unit 11 display a predetermined input form, and specifies and sets the format information 15a in accordance with a user's operation of the input unit 12. The input form may be one letting the user input the arrangement method of a medical image in the numerical form of “the number of horizontal frames×the number of vertical frames” such as “2×2” or “3×3”, or may be one letting the user graphically input the arrangement of the medical image by the movement of the predetermined icon showing the medical image.

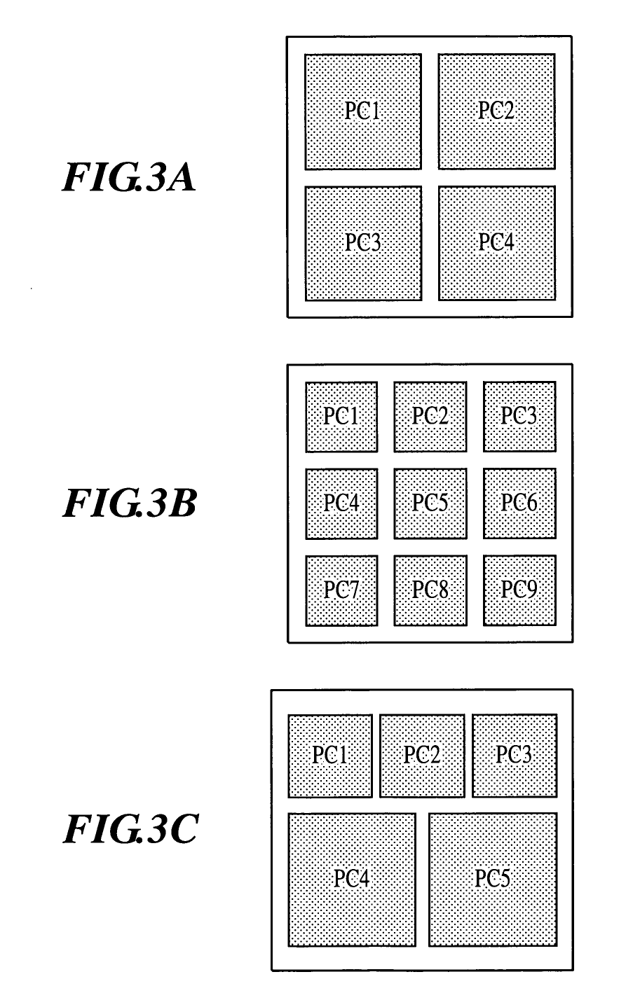

FIGS. 3A-3C are views showing examples of formats at the time of arranging a medical image according to the format information 15a. For example, by the format information 15a indicating the arrangement method of “2×2”, the medical image is arranged as medical images PC1-PC4 as shown in FIG. 3A. Moreover, by the format information 15a indicating the arrangement method of “3×3”, the medical image is arranged as medical images PC1-PC9 as shown in FIG. 3B. Moreover, by the format information 15a indicating an arrangement method of “arranging three frames of medical images in a first row and two frames of medical images in a second row”, the medical image is arranged as medical images PC1-PC5 as shown in FIG. 3C. As mentioned above, the arrangement method of the medical image can be suitably specified by the controller 2a.

The film size 15b is the size information of a film on which a medical image is formed as images, and is set by the user. The CPU 10 of the controller 2a transmits the format information 15a and the film size 15b to the conversion apparatus 3a through the communication interface unit 13 according to an instruction input by the user. In addition, although the configuration in which the format information 15a and the film size 15b are set with the controllers 2a and 2b is adopted, the configuration is not limited to that one. For example, the format information 15a and the film size 15b may be settable with the diagnosis apparatus 1a and 1b.

In addition, hereinafter, the description is given on the supposition that the format information of FIG. 3A is used as the format information, but the situation is similar in the case of using the other formats.

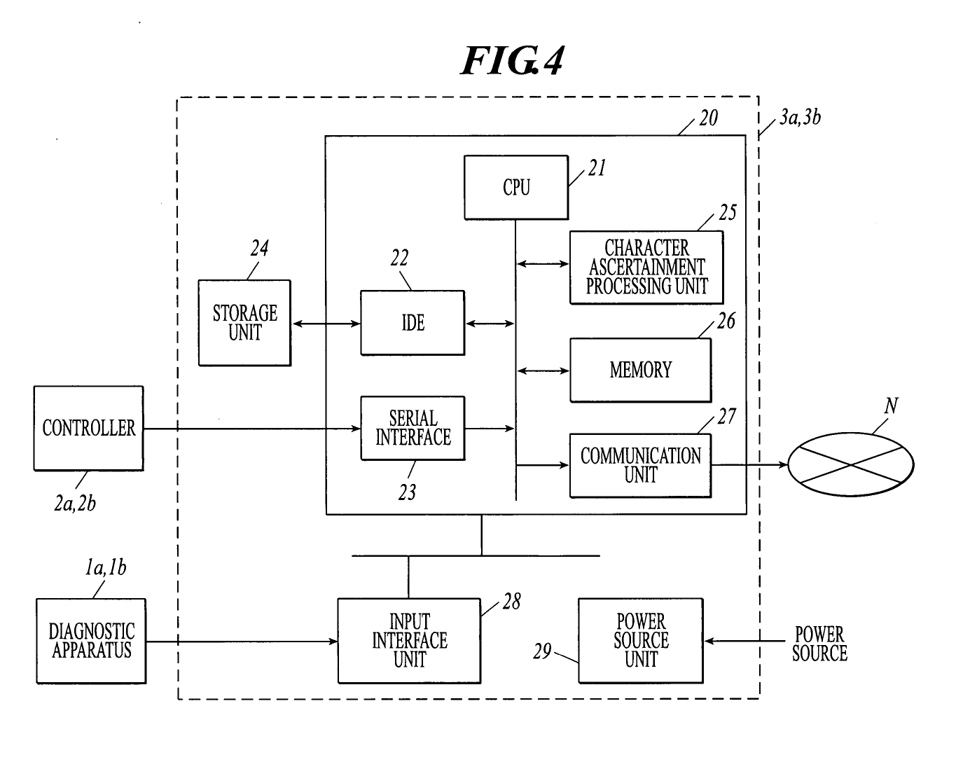

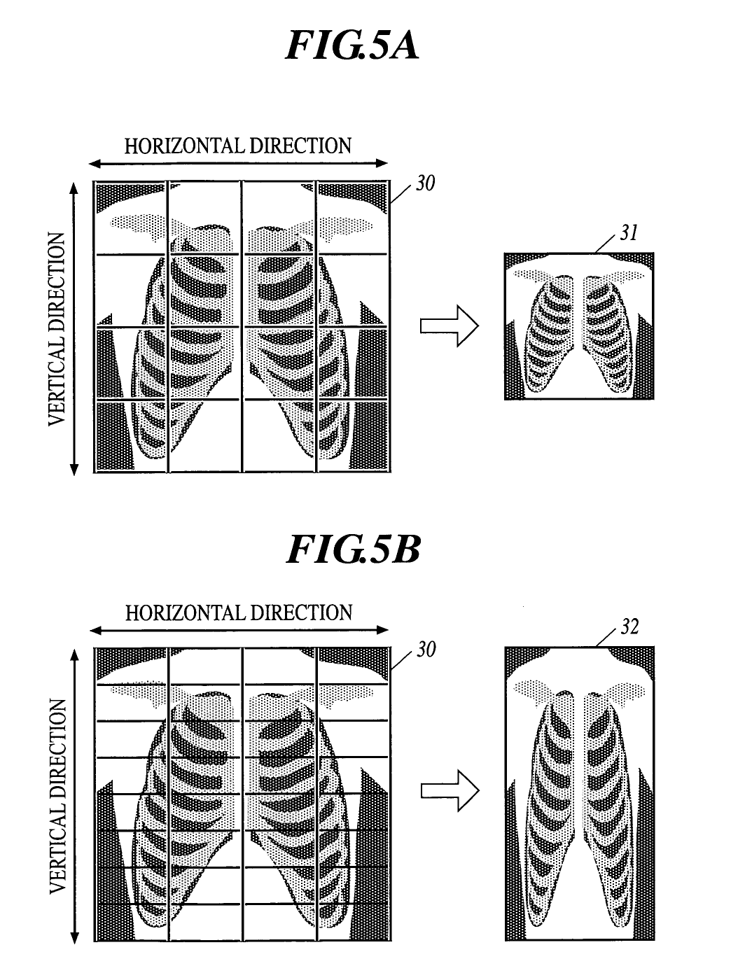

Next, FIG. 4 shows an example of the configuration of the principal part of the conversion apparatus 3a. As shown in the diagram, the conversion apparatus 3a is composed of a control unit 20, a storage unit 24, an input interface unit 28, a power source unit 29 and the like.

The storage unit 24 is a function unit equipped with a storage medium performing the optical or magnetic reading and writing of data, and is made of, for example, a HDD or the like.

The power source unit 29 supplies electric power to each unit of the conversion apparatus 3a and 3b.

The control unit 20 is composed of a CPU 21, an integrated drive electronics (IDE) 22, a serial interface 23, a character ascertainment processing unit 25, a memory 26 and a communication apparatus 27.

The CPU 21 reads the program stored in the storage unit 24, and controls the operation of each unit according to the read program. To put it concretely, when the CPU 21 receives medical image data output from the diagnosis apparatus 1a and 1b through the input interface unit 28, the CPU 21 acquires a medical image, an image size and an aspect ratio from the received medical image data. Because the aspect ratios differ from each other according to the kind of the diagnosis apparatus 1a and 1b, it is necessary to perform processing in consideration of these differences (it will be described later). Moreover, when the CPU 21 receives the medical image data, the CPU 21 controls the character ascertainment processing unit 25 to acquire patient information by performing character recognition by the character pattern included in the medical image data, matching, an OCR and the like. In addition, a well-known technique may be suitably used as the technique of recognizing the characters in the medical image data.

On the other hand, the CPU 21 receives the format information and the film size, each transmitted from the controllers 2a and 2b, through the serial interface 23. Then, the CPU 21 creates template data from the patient information acquired by character recognition and the image to be subjected to image processing, and the CPU 21 transmits the created template data to the film output apparatus 4a and 4b through the communication apparatus 27.

The memory 26 is a storage region in which various programs which the CPU 21 executes, the data which the various programs execute, and the like are temporarily stored.

FIGS. 5A and 5B show examples of the medical images transmitted from the diagnosis apparatus 1a and 1b having different aspect ratios.

FIG. 5A shows a medical image having the aspect ratio of 1:1, FIG. 5B shows a medical image having the aspect ratio of 1:2. The ratios of the vertical sizes and the horizontal sizes per one pixel of input devices of images differ from each other according to the specifications of the diagnosis apparatus 1a and 1b. A pixel aspect ratio is a ratio of the vertical size and the horizontal size of a pixel. Consequently, as shown in the views, the medical image transmitted when the aspect ratio is 1:1 becomes a regular square as a medical image 31, namely an image acquired by reducing the original medical image 30.

On the other hand, as shown in FIG. 5B, the medical image transmitted when the aspect ratio is 1:2 becomes a medical image 32 which has been enlarged in the vertical direction. That is, because the medical image 32 is seen in a way different from the actual image, the user cannot perform reliable diagnosis. Accordingly, it is necessary to perform image processing to the medical images transmitted from the diagnosis apparatus 1a and 1b having an aspect ratio set not to be 1:1.

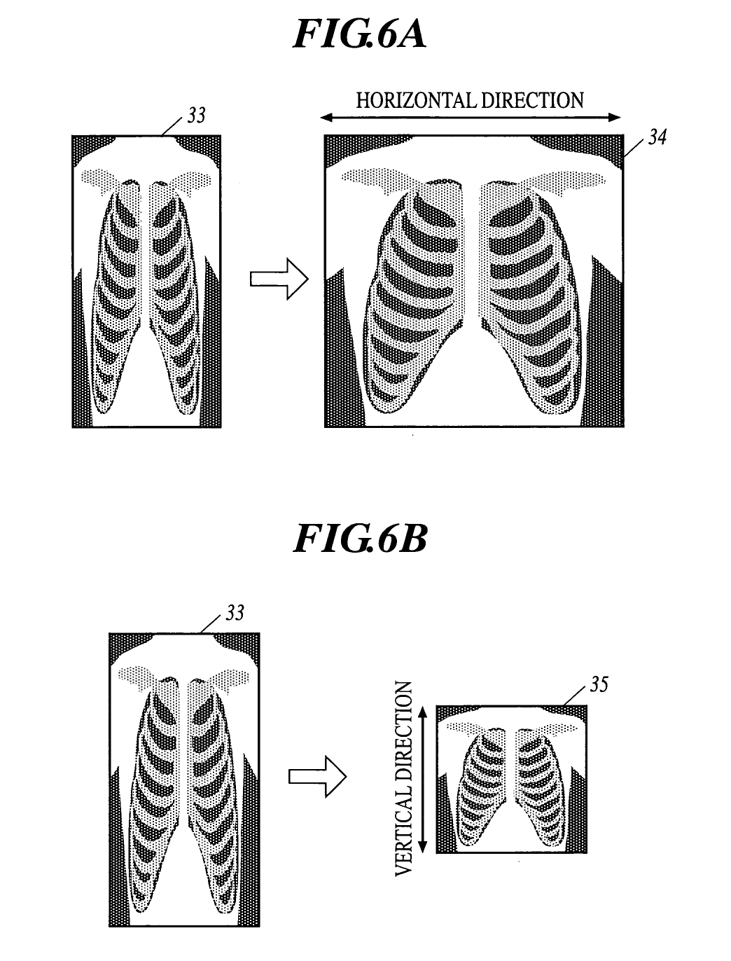

FIGS. 6A and 6B show examples of medical images which have been generated by enlarging or reducing the image data transmitted from the diagnosis apparatus 1a and 1b having an aspect ratio set to be 1:2.

In the case of the image having an aspect ratio of not being 1:1, the image is enlarged or reduced so as to have an aspect ratio of 1:1. As shown in the views, in case of a medical image 33 having an aspect ratio of 1:2, a medical image 34 is generated by enlarging the medical image 33 to be twice in the horizontal direction (FIG. 6A). Moreover, a medical image 35 having the aspect ratio of 1:1 may be also created by reducing the medical image 33 to be half in the vertical direction (FIG. 6B). In such a way, by embedding the image subjected to the image processing into the template created beforehand, a new template is created, and the new template is output to the output apparatus.

Here, enlargement/reduction processing of a medical image based on an aspect ratio is described. First, it is supposed that the aspect ratio is a:b and an image size is X pixels in the horizontal direction and Y pixels in the vertical direction.

[Case of Enlargement Processing]

When the aspect ratio meets the condition of a>b, the values of Y pixels in the vertical direction are enlarged so that the image size in the vertical direction may become a/b×X pixels on the basis of the X pixels in the horizontal direction. When the aspect ratio meets the condition of a<b, the values of X pixels in the horizontal direction are enlarged so that the image size in the horizontal direction may become b/a×Y pixels on the basis of the Y pixels in the vertical direction.

[Case of Reduction Processing]

When an aspect ratio meets the condition of a>b, the values of X pixels in the horizontal direction are reduced so that the image size in the horizontal direction may become b/a×Y pixels on the basis of the Y pixels in the vertical direction. When the aspect ratio meets a<b, the values of Y pixels in the vertical direction are reduced so that the image size in the vertical direction may become a/b×X pixels on the basis of the X pixels in the horizontal direction.

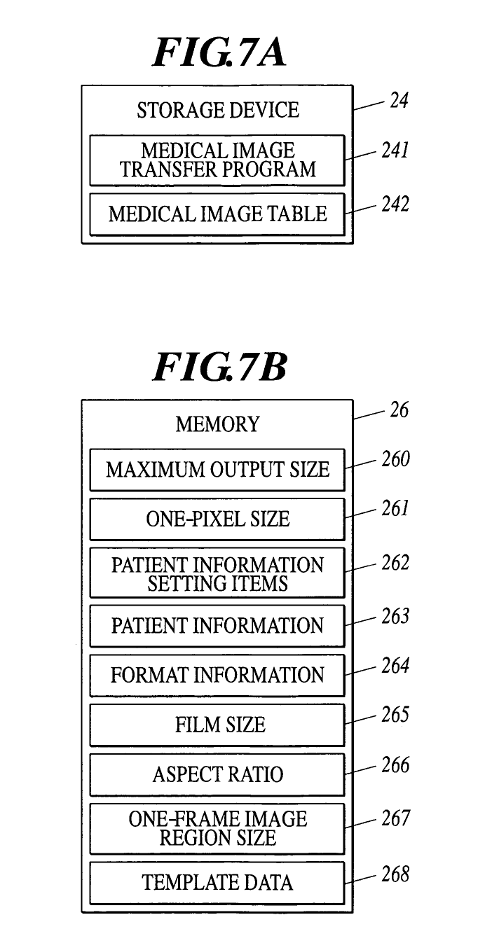

FIGS. 7A and 7B show examples of the data configurations of the storage unit 24 and the memory 26 of the conversion apparatus 3a and 3b according to the first embodiment. FIG. 7A shows an example of the data configuration of the storage unit 24, and FIG. 7B shows an example of the data configuration of the memory 26.

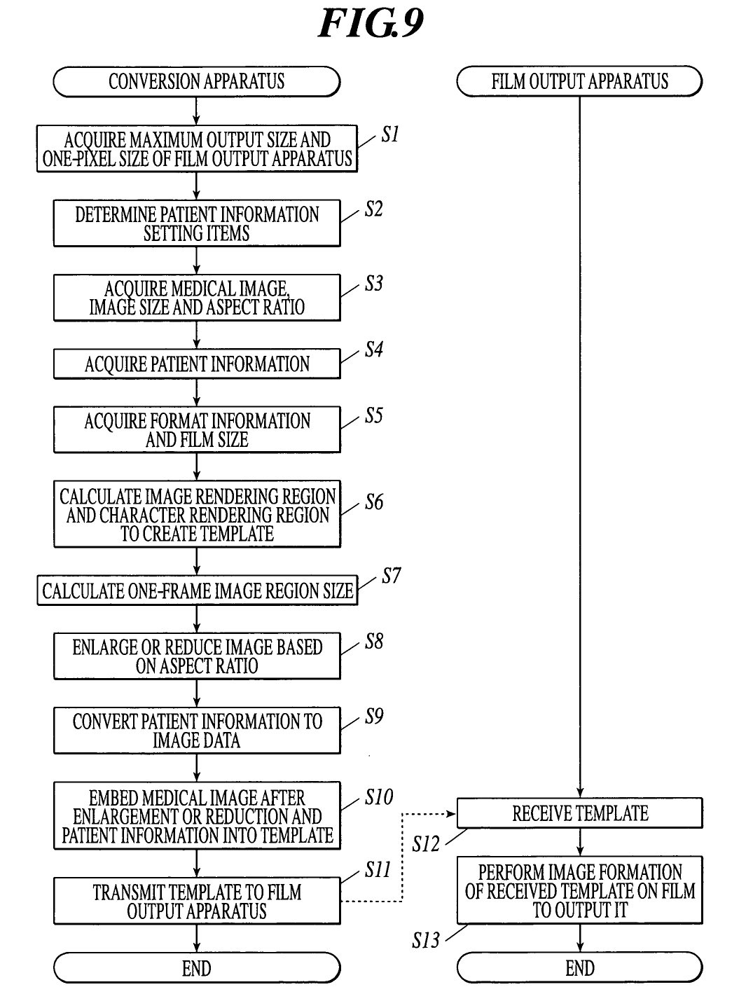

As shown in FIG. 7A, the storage unit 24 stores a medical image transfer program 241 and a medical image table 242. The medical image transfer program 241 is a program for realizing medical image transfer processing (see FIG. 9). The medical image table 242 is a data table accumulatively storing medical image data transmitted from the diagnosis apparatus 1a and 1b.

As shown in FIG. 7B, the memory 26 stores a maximum output size 260, a one-pixel size 261, patient information setting items 262, patient information 263, format information 264, a film size 265, an aspect ratio 266, a one-frame image region size 267 and template data 268. The CPU 21 creates a template based on the maximum output size 260, the one-pixel size 261, the patient information setting items 262, the patient information 263, the format information 264, the film size 265, the aspect ratio 266 and the one-frame image region size 267. The template data 268 is a piece of medical image data acquired by arranging medical image data enlarged or reduced based on the aspect ratio 266 and the patient information 263 based on the format information 264 to synthesize them, i.e. a template image.

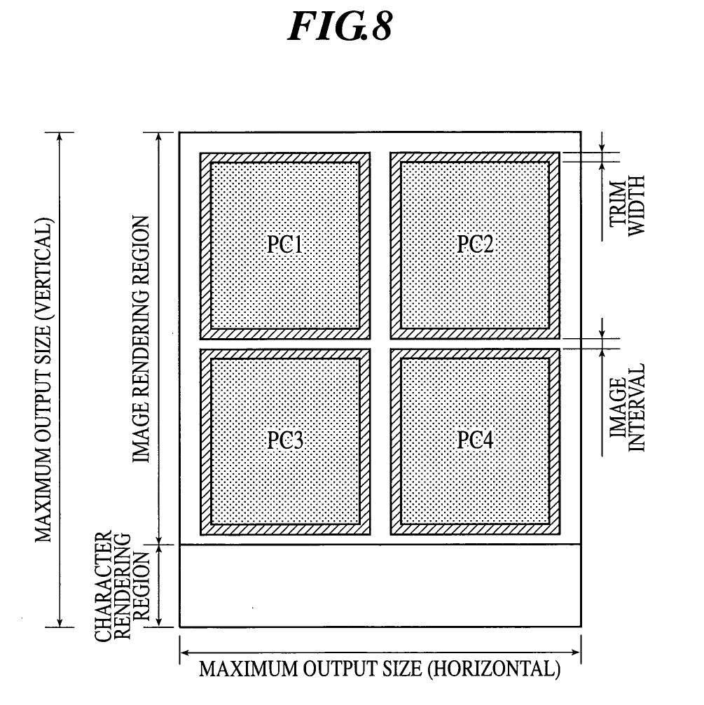

Next, with reference to the flowchart of FIG. 9, the processing executed by the conversion apparatus 3a is described, referring to FIG. 8.

First, when the CPU 21 starts medical image transfer processing, the CPU 21 acquires the maximum output size 260 of each film, which size 260 has been set to the film output apparatus 4a beforehand, and the one-pixel size 261 from the film output apparatus 4a (Step S1).

The maximum output size 260 is image formation region information, and expresses the maximum region of each film in which medical images and patient information can be formed as images by the numbers of pixels of the vertical sides and the horizontal sides. The one-pixel size is the size of one dot at the time when the film output apparatus 4a performs image formation.

When the CPU 21 has acquired the maximum output size 260 and the one-pixel size 261 of each film at Step S1, the CPU 21 determines the patient information setting items 262 (Step S2). The patient information setting items 262 are a kind of the item of the patient information to be formed on a film as an image, and the like.

When the CPU 21 has determined the patient information setting items 262 at Step S2, the CPU 21 receives the medical image data transmitted from the diagnostic apparatus 1a through the input interface unit 28. Then, the CPU 21 acquires a medical image, an image size and an aspect ratio from the received medical image data (Step S3).

When the CPU 21 has acquired the medical image, the image size and the aspect ratio from the received medical image data at Step S3, the CPU 21 performs the character recognition of the received medical image data to acquire the patient information 263 (Step S4). The patient information 263 indicates a patient ID, a patient name, the distinction of sex, an age, a hospital management number and the like. The medical image output system 50 is configured so that a patient management server, though it is not shown, is connected to the conversion apparatus 3a, and that the conversion apparatus 3a acquires the patient information equivalent to the patient ID from the patient management server when it was impossible to acquire the detailed patient information by the character recognition.

When the CPU 21 has acquired the patient information 263 at Step S4, the CPU 21 acquires the format information 264 and the film size 265 transmitted from the controller 2a through the serial interface 23 (Step S5). The format information 264 and the film size 265 are the information set by the diagnostic apparatus 1a.

When the CPU 21 has acquired the format information 264 and the film size 265 of the medical image data at Step S5, the CPU 21 calculates an image rendering region and a character display region using these pieces of information to create a template (Step S6). The calculation method of the image rendering region and the character display region is shown below. In addition, the initial setting of the actual size values (lengths) of the minimum image interval, a trim width, a character size and the number of character rows is beforehand performed by the user.
minimum image interval (pixel)=minimum image interval/one-pixel size
trim width (pixel)=trim width (actual size)/one-pixel size
character height (pixel)=character size (actual size)/one-pixel size
character display region; horizontal (pixel)=number of pixels capable of being output; horizontal
character display region; vertical (pixel)=character height (actual size)×number of output rows
image display region; horizontal (Pixel)=number of pixels capable of being output horizontal−((trim width×2×number of horizontal frames)+(minimum image interval×number of horizontal frames−1))
image display region; vertical (pixel)=number of pixels capable of being output vertical−((trim width×2×number of vertical frames)+(minimum image interval×(number of vertical frames−1))−character region; vertical

When the CPU 21 has calculated the image rendering region and the character display region to create the template at Step S6, the CPU 21 calculates the one-frame image region size 267 (Step S7). The calculation method thereof is shown below.
one-frame image region size; horizontal (pixel)=image depiction region; horizontal (pixel)/number of horizontal frames
one-frame image region size; vertical (pixel)=image depiction region/vertical (pixel)/number of vertical frames

When the CPU 21 has calculated the one-frame image region size 267 at Step S7, the CPU 21 performs the enlargement or the reduction of the image based on the aspect ratio 266 (Step S8).

When the CPU 21 has performed the enlargement or the reduction of the image based on the aspect ratio 266 at Step S8, the CPU 21 converts the patient information acquired at Step S4 into image data (Step S9). Here, by the conversion of the patient information 263, which is character information, into the image data, the film output apparatus 4a simply performs the image formation of the patient information which is image data.

When the CPU 21 has converted the patient information into the image data at Step S9, the CPU 21 embeds the medical image which have been enlarged or reduced at Step S8 and the patient information converted into the image data at Step S9 into one-frame image region of the template created at Step S6 (Step S10), and performs the formatting thereof. Thus, the CPU 21 creates the template data, which is the image data in conformity with the DICOM standard. Hereupon, the size of the template data to be created is not made to correspond to the received aspect ratio, but is transmitted to the film output apparatus 4a in the size of the aspect ratio of 1:1.

When the CPU 21 has transmitted the template data to the film output apparatus 4a at Step S11, the CPU 21 ends the processing.

On the other hand, when the film output apparatus 4a receives the transmitted template data from the conversion apparatus 3a (Step S12), the film output apparatus 4a outputs the medical image based on the template data on a film by performing the image formation thereof (Step S13), and the film output apparatus 4a ends the processing.

As described above, when the conversion apparatus 3a receives the medical image having an aspect ratio of not 1:1 such as 1:2 and 1:3, the conversion apparatus 3a performs the image processing of the medical image to convert the aspect ratio to be 1:1, and outputs the converted medical image in the state of being embedded into a previously set template. Thereby, even if the aspect ratios are different in the respective diagnosis apparatus 1a and 1b, the medical image output system 50 can generate the template data based on the medical image having the unified aspect ratio of 1:1, and can output the generated template data. Consequently, the medical image output system 50 can always create the medical image having the aspect ratio of 1:1 to supply the optimum medical image to the user independent of the specifications of the diagnostic apparatus 1a and 1b.

### Second Embodiment

Next, the medical image output system 50 according to a second embodiment is described. Since the system configuration of the medical image output system 50 according to the second embodiment is the same as that of FIG. 1, the illustration and the description of the system configuration are omitted. Moreover, because the configurations of the principal parts of the controllers 2a and 2b and the conversion apparatus 3a and 3b, each constituting the medical image output system 50, are the same as those of FIGS. 2 and 4, the description and the illustration of the configurations are omitted.

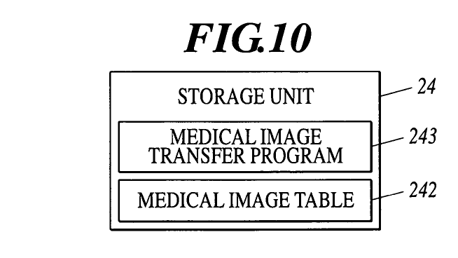

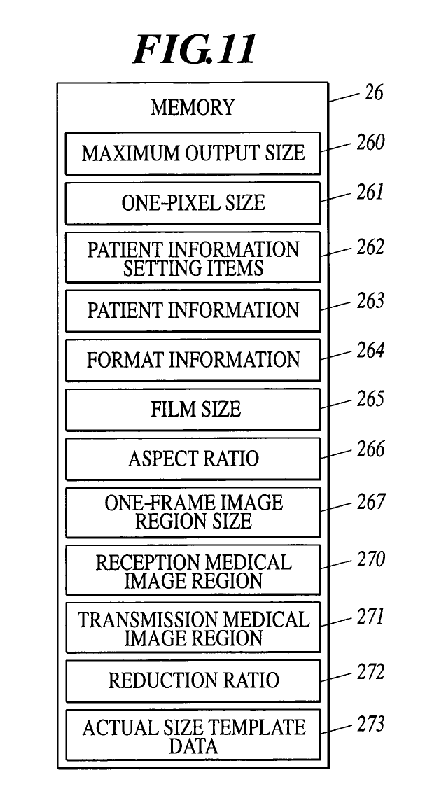

FIG. 10 is a diagram showing an example of the data configuration of the storage unit 24 according to the second embodiment. As shown in the diagram, the storage unit 24 stores a medical image transfer program 243 according to the second embodiment and the medical image table 242. The medical image transfer program 243 is a program for executing the medical image transfer processing according to the second embodiment.

Next, FIG. 11 shows an example of the data configuration of the memory 26 according to the second embodiment. As shown in the diagram, the memory 26 stores the maximum output size 260, the one-pixel size 261, the patient information setting items 262, the patient information 263, the format information 264, the film size 265, the aspect ratio film 266, the one-frame image region size 267, a reception medical image region 270, a transmission medical image region 271, a reduction ratio 272 and an actual size template data 273.

The CPU 21 creates the actual size template data 273 after having calculated the one-frame image region size 267 using various kinds of information stored in the memory 26 similarly to the first embodiment. In the first embodiment, the template data 268 is created based on the format information 264 and the film size 265. Then, the image data transmitted in various aspect ratios are converted into the image data having the aspect ratio of 1:1, and then are enlarged or reduced in order to be able to enter the created template. After that, the converted image data is embedded into the template. Thereby, the actual size template data 273 is created by adjusting the actual size template data to the sizes and the aspect ratios of the medical image data transmitted in the respective aspect ratios.

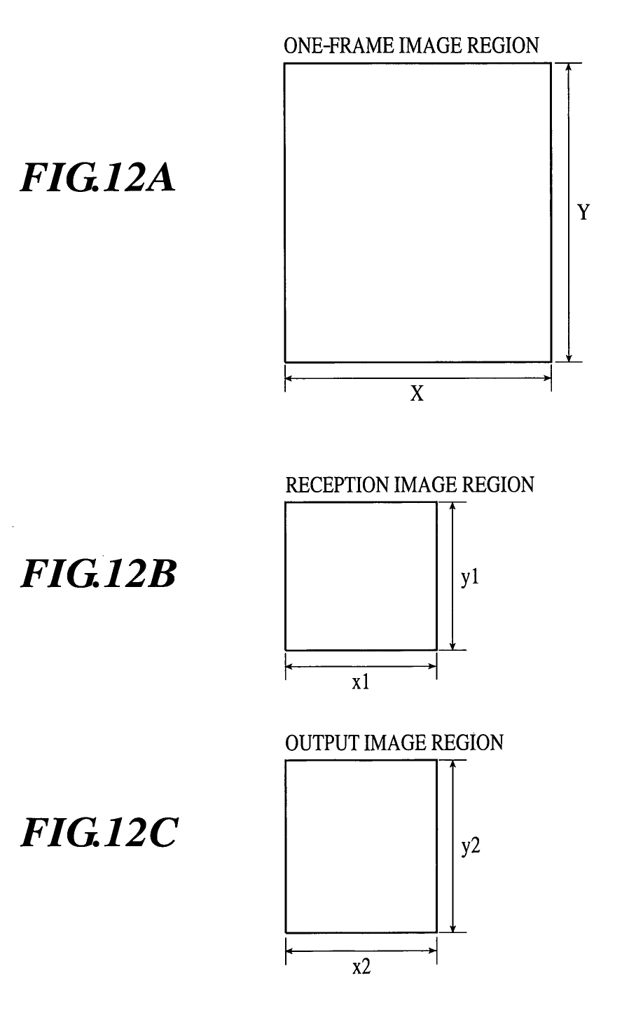

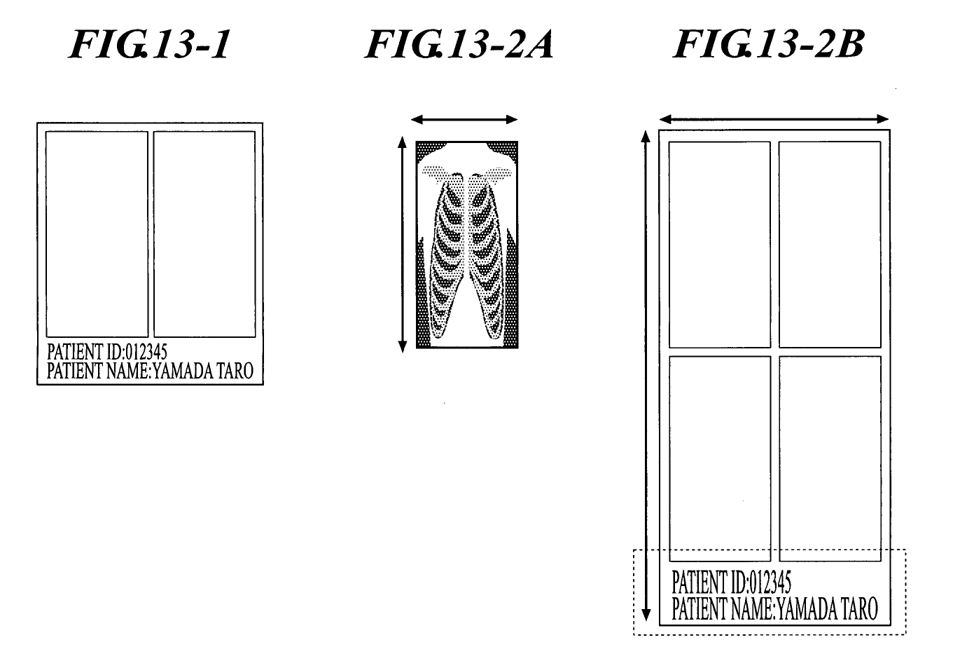

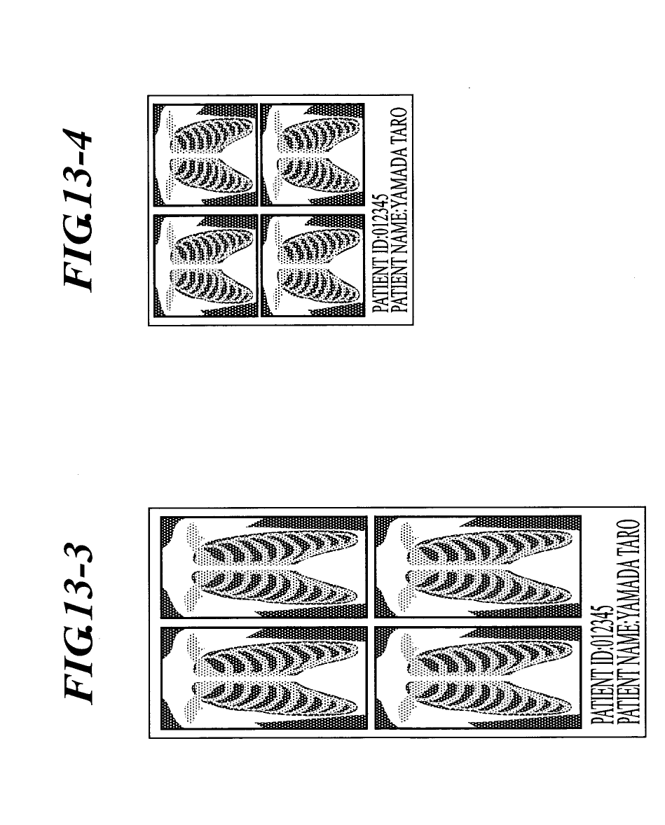

Next, with reference to FIGS. 12A-12C, 13(1)-13(4) and 14, the flowchart of FIG. 15 showing the processing performed by the conversion apparatus according to the second embodiment is described.

First, when the CPU 21 starts medical image transfer processing, the CPU 21 acquires the maximum output size 260 of each film, which size 260 has been set to the film output apparatus 4a beforehand, and the one-pixel size 261 from the film output apparatus 4a (Step T1).

The maximum output size 260 is image formation region information, and expresses the maximum region of each film in which a medical image and patient information can be formed as images by the numbers of pixels of the vertical sides and the horizontal sides. The one-pixel size is the size of one dot at the time when the film output apparatus 4a performs image formation.

When the CPU 21 has acquired the maximum output size 260 and the one-pixel size 261 of each film at Step T1, the CPU 21 determines the patient information setting items 262 (Step T2). The patient information setting items 262 are a kind of the item of the patient information to be formed on a film as an image, and the like.

When the CPU 21 has determined the patient information setting items 262 at Step T2, the CPU 21 receives the medical image data transmitted from the diagnostic apparatus 1a through the input interface unit 28. Then, the CPU 21 acquires the medical image, an image size and an aspect ratio from the received medical image data (Step T3).

When the CPU 21 has acquired the medical image, the image size and the aspect ratio from the received medical image data at Step T3, the CPU 21 calculates the pixel values in the horizontal directions and the vertical directions at which pixel values the medical image having the specified aspect ratio become the medical image having the aspect ratio of 1:1 (Step T4). The calculation method is described below. In addition, it is supposed that the aspect ratio is a:b and an image size is X pixels in the horizontal direction and Y pixels in the vertical direction.

[Case of Enlargement Processing]

When the aspect ratio meets the condition of a>b, the values of the pixels to be calculated are X pixels in the horizontal direction and a/b×X pixels in the vertical direction.

When the aspect ratio meets the condition of a<b, the values of pixels to be calculated are b/a×Y pixels in the horizontal direction and Y pixels in the vertical directions.

[Case of Reduction Processing]

When an aspect ratio meets the condition of a>b, the values of pixels to be calculated are b/a×Y pixels in the horizontal direction and Y pixels in the vertical direction.

When the aspect ratio meets a<b, the values of pixels to be calculated are X pixels in the horizontal direction and a/b×X pixels in the vertical direction.

When the CPU 21 has calculated the pixel values in the horizontal direction and the vertical direction at which the aspect ratio of the medical image become 1:1 at Step T4, the CPU 21 acquires patient information 263 by performing the character recognition of the received medical image (Step T5). The patient information 263 indicates a patient ID, a patient name, the distinction of sex, an age, a hospital management number and the like. The medical image output system 50 is configured so that a patient management server, though it is not shown, is connected to the conversion apparatus 3a, and that the conversion apparatus 3a acquires the patient information equivalent to the patient ID from the patient management server when it was impossible to acquire the detailed patient information 263 by the character recognition.

When the CPU 21 has acquired the patient information 263 at Step T5, the CPU 21 acquires the format information 264 and the film size 265 transmitted from the controller 2a through the serial interface 23 (Step T6). The format information 264 and the film size 265 are the information set by the diagnostic apparatus 1a.

When the CPU 21 has acquired the format information 264 and the film size 265 of the medical image data at Step T6, the CPU 21 calculates an image rendering region and a character display region using these pieces of information to create an actual size template (Step T7). Because the calculation method of the image rendering region and the character display region is similar to that of the first embodiment, the description thereof is omitted.

When the CPU 21 has calculated the image rendering region and the character display region to create the actual size template at Step T7, the CPU 21 calculates the one-frame image region size 267 (Step T8). Because the calculation method thereof is also similar to that of the first embodiment, the description thereof is omitted.

When the CPU 21 has calculated the one-frame image region size 267 at Step T8, the CPU 21 calculates the reduction ratio of the one-frame image size based on the calculated one-frame image region size 267 and the aspect ratios (Step T9). The calculation method is shown below. In addition, FIGS. 12A-12C are referred to.

(1) First, output image region; vertical y1 is calculated on the basis of one-frame image region; horizontal X.
y2=(x2×Y)/X from x2:y2=X:Y
output image region; horizontal [x2]=reception image region; horizontal [x1]
output image region; vertical [y2]=one-frame image region; vertical [Y]×output image region; horizontal [x2]/one-frame image region;horizontal [X]

(2) When output image region; vertical [y2] is smaller than reception image region; vertical [y1] on the basis of horizontal (1), re-calculation is performed on the basis of reception image region; vertical.
output image region; horizontal [x2]=one-frame image region; horizontal [X]×output image region; vertical [y2]/one-frame image region; vertical [Y]
output image region; vertical [y2]=reception image region; vertical [y1]

(3) Reduction ratio is calculated based on output image region (x2, y2) . At this time, a calculation result to be used changes depending on which one of vertical and horizontal is used as a reference value.
reduction ratio (horizontal basis) in case of (1)=reception image region; vertical [y1]/one-frame image region; vertical [Y]
reduction ratio (vertical basis) in case of (2)=reception image region; horizontal [x1]/one-frame image region; horizontal [X]

When the CPU 21 has calculated the reduction ration of one-frame image region in accordance with the calculation method described above, the CPU 21 creates template outputting the values calculated by the actual size template at the reduction ratio acquired at Step T9 (Step T10). The calculation method is shown in the following.
minimum image interval [output]=minimum image interval [actual size]×reduction ratio
trim width [output]=trim width [actual size]×reduction ratio

when minimum image interval [output] and trim width [output] are smaller than 1, they are set to be 1
character height [output]=character height [actual size]×reduction ratio
character region; vertical [output]=character height [output]×number of output rows
character region; horizontal [output]=output image region; horizontal
number of characters capable of being output; horizontal=output image region; horizontal/((character height [output]/2.4)×2)
output image region; horizontal=(one-frame image region [output]×number of horizontal frames)+(trim width×2×number of horizontal frames)+(minimum image interval [output]×(number of horizontal frames−1))
output image region; vertical=(one-frame image region [output]×vertical frame number)+(trim width×2×vertical frame number)+(minimum image interval [output]×(vertical frame number−1)+character region vertical [output]

When the CPU 21 has created the template in accordance with the calculation method described above at Step T10, the CPU 21 writes the trim and the patient information into the template (Step T11, FIG. 13-1). Then, when the CPU 21 has written the trim and the patient information into the template at Step T11, the CPU 21 enlarges or reduces the template of FIG. 13-1 in accordance with the received one-frame image (FIG. 13-2A) having an aspect ratio of not 1:1 (Step T12, FIG. 13-2B).

When the CPU 21 has enlarged or reduced the template in accordance with the received one-frame image having the aspect ratio of not 1:1 at Step T12, the CPU 21 embed one-frame image into the enlarged or reduced template (Step T13, FIG. 13-3).

When the CPU 21 has embedded the one-frame image having the aspect ratio of not 1:1 into the enlarged or reduced template at Step T13, the CPU 21 transmits the template to the film output apparatus 4a (Step T14), and ends the processing.

When the film output apparatus 4a receives the template from the conversion apparatus (Step T15), the film output apparatus 4a performs the enlargement or reduction processing of the received template in accordance with the film (Step T16, FIG. 13-4).

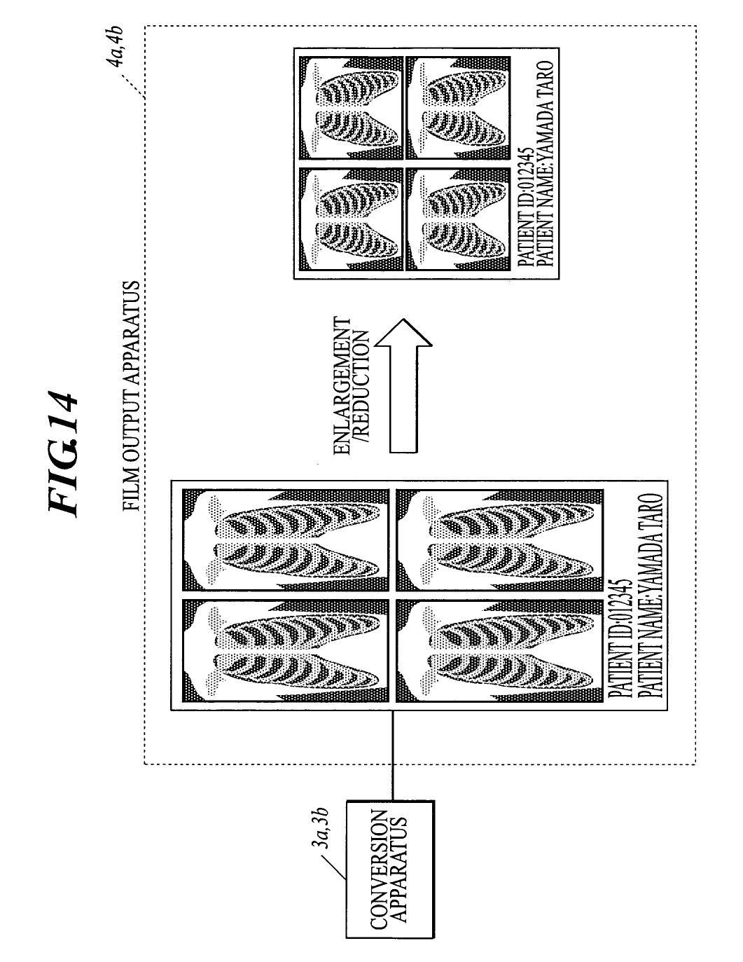

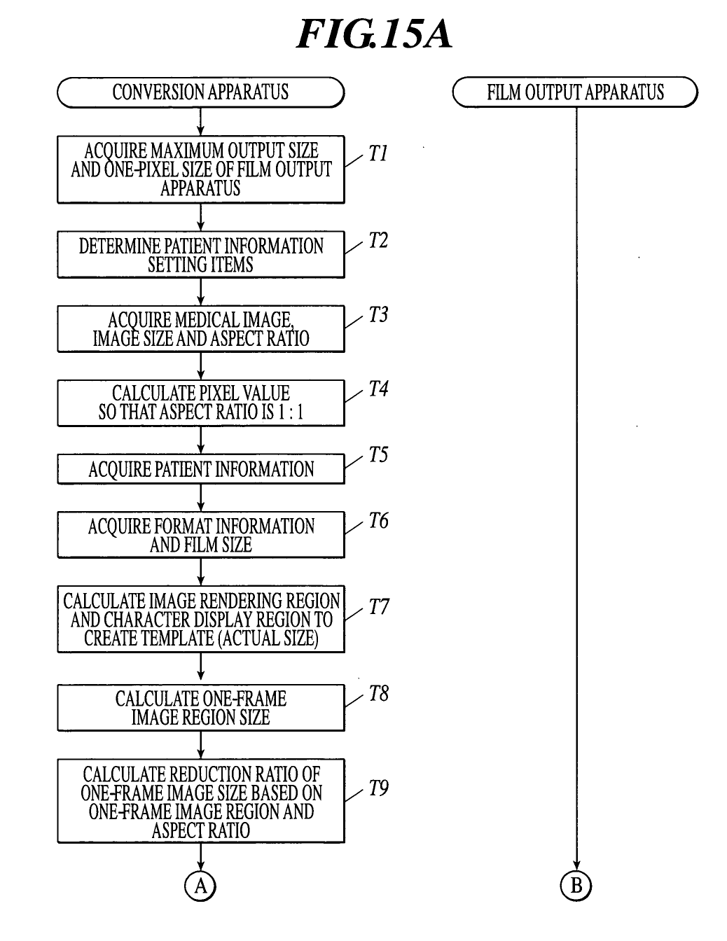

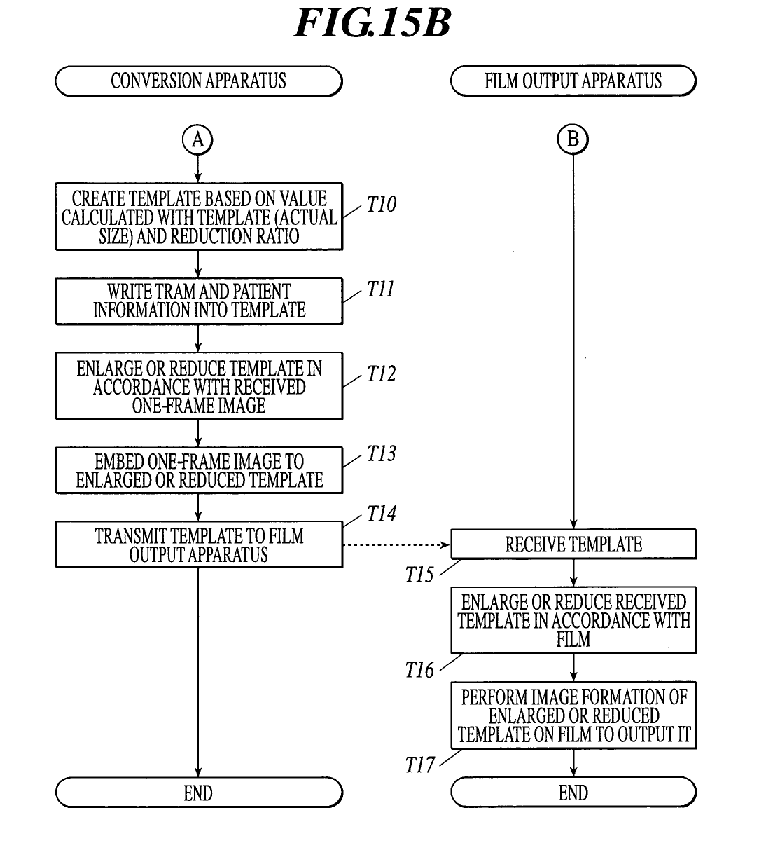

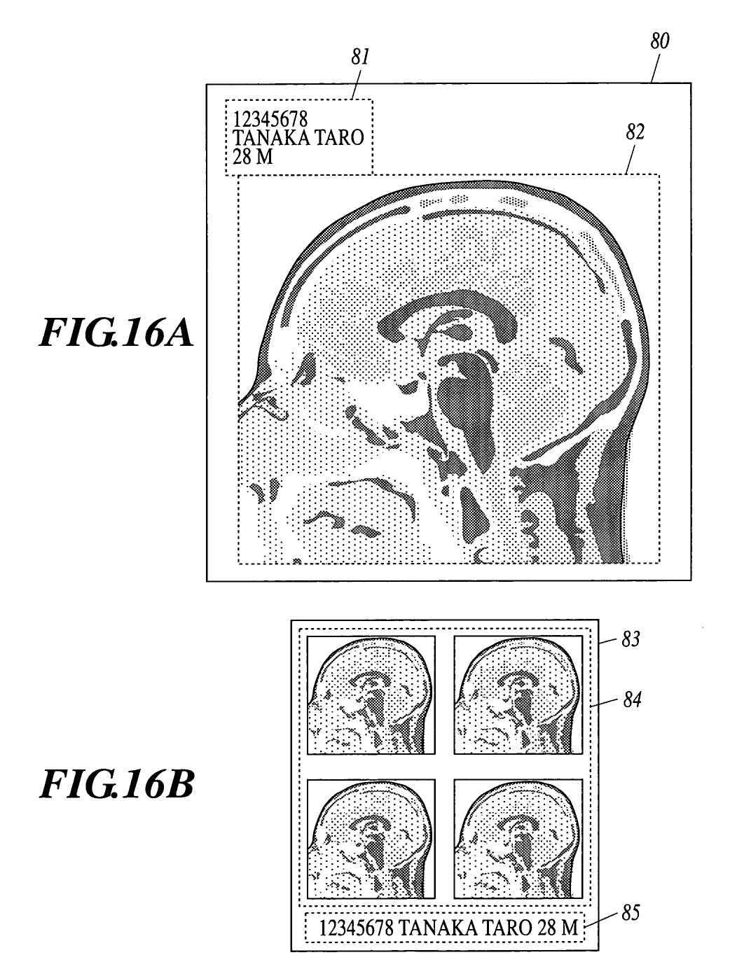

When the film output apparatus 4a has performed the enlargement or reduction processing of the received template in accordance with the film at Step T16, the film output apparatus 4a performs the image formation of the enlarged or reduced template on the film to output the template (Step T17), and ends the processing (see FIG. 14).

As described above, when the conversion apparatus 3a receives a medical image having an aspect ratio of not 1:1, the conversion apparatus 3a does not perform the image processing of the medical image, but converts the template having the aspect ratio of 1:1, which template has been previously created by the set format information. After that, the medical image is embedded into the converted template data. Then, the template data generated by embedding the medical image having the aspect ratio of not 1:1 is transmitted to the film output apparatus 4a. After that, the template data is converted to have the aspect ratio of 1:1 by the film output apparatus 4a, and thereby the number of times of the image processing performed to a medical image can be decreased. Consequently, because the deterioration of the image data generated by the performance of the image processing can be suppressed to the minimum, the medical image data of a clear image can be generated. Hence, it is also possible to escape an erroneous diagnosis which can be caused by the deterioration of image. Moreover, because there is no need to perform image processing to the received medical image, the time required to the image processing can be shortened, and the working efficiency can be improved.

The present application is based on Japanese Patent Application No. 2005-176262 filed on Jun. 16, 2005.

What is claimed is:

1. A medical image output system comprising:
a medical image conversion apparatus to convert a file format of medical image data including received medical image information and patient character information into a predetermined data format, and to transfer the converted medical image data; and
a medical image formation apparatus to form an image of the transferred medical image data in the predetermined data format on a recording medium,
wherein the medical image conversion apparatus comprises:
a reception section to receive the medical image data;
a storage section to store a template in which the medical image information is embedded, among the medical image data received by the reception section;
a conversion section to convert the template stored in the storage section in accordance with an aspect ratio of the medical image information;
a template data generation section to embed the medical image information into the template converted by the conversion section so as to generate template data; and
a transfer section to transfer the template data generated by the template data generation section to the medical image formation apparatus, and
wherein the medical image formation apparatus comprises:
a template data conversion section to convert the template data transferred from the transfer section to have an aspect ratio of the original template stored in the storage section; and
an image formation member to form an image of the template data converted by the template data conversion section onto the recording medium.

2. The medical image output system of claim 1, wherein the medical image conversion apparatus further comprises: a specification section to specify format information which indicates an arrangement method of the medial image data including the medical image information and the patient character information on the recording medium, and
wherein the storage section stores the template formed in conformity with the format information specified by the specification section.

3. The medical image output system of claim 1, wherein, when the reception section receives the medical image data having an aspect ratio of not 1:1, the conversion section converts the template so as to have the same aspect ratio as the aspect ratio of the received medical image information.

4. The medical image output system of claim 1, wherein the template data conversion section converts the aspect ratio of the template data generated by the template data generation section into the same aspect ratio as the aspect ratio of the template.

5. The medical image output system of claim 1, wherein the template stored in the storage section has the aspect ratio of 1:1.

6. The medical image output system of claim 1, wherein the conversion section converts the template data so as to have the same aspect ratio as the aspect ratio of the medical image information after the patient character information is written into the template.

7. A medical image conversion apparatus, comprising:
a reception section to receive medical image data including medical image information and patient character information;
a storage section to store a template in which the medical image information is embedded among the medical image data received by the reception section;
a medical image information conversion section to convert an aspect ratio of the medical image information into a same aspect ratio as the aspect ratio of the template stored in the storage section;
a template data generation section to embed the medical image information converted by the medical image information conversion section into the template so as to generate template data; and
a transfer section to transfer the template data generated by the template data generation section.

8. The medical image conversion apparatus of claim 7, wherein the medical image information conversion section converts the aspect ratio of the medical image information into 1:1.

9. A medical image output program comprising:
a medical image conversion program to convert a file format of medical image data including received medical image information and patient character information into a predetermined data format, and to transfer the converted medical image data; and
a medical image formation program to form an image of the transferred medical image data in the predetermined data format on a recording medium,
wherein the medical image conversion program makes a computer function as:
a reception section to receive the medical image data;
a storage section to store a template in which the medical image information is embedded, among the medical image data received by the reception section;
a conversion section to convert the template stored in the storage section in accordance with an aspect ratio of the medical image information;
a template data generation section to embed the medical image information into the template converted by the conversion section so as to generate template data; and
a transfer section to transfer the template data generated by the template data generation section to the medical image formation apparatus, and
wherein the medical image formation program makes a computer function as:
a template data conversion section to convert the template data transferred from the transfer section to have an aspect ratio of the original template stored in the storage section; and
an image formation member to form an image of the template data converted by the template data conversion section onto the recording medium.
